(19) United States
(12) Patent Application Publication
(10) Pub. No.: US 2021/0290993 A1
(43) Pub. Date: Sep. 23, 2021

(54) Nonwoven Filtration Media

(71) Applicant: Berry Global, Inc., Evansville, IN (US)

(72) Inventors: Alberto Callado, Barcelona (ES); Robert Garcia, Alcanar (ES); Elisabeth Torres Cano, Barcelona (ES)

(21) Appl. No.: 17/206,629

(22) Filed: Mar. 19, 2021

Related U.S. Application Data
(60) Provisional application No. 62/992,199, filed on Mar. 20, 2020.

(51) Int. Cl. A62B 23/02; A41D 13/11; D04H 1/56

(52) U.S. Cl. CPC A62B 23/025; A41D 2500/30; D04H 1/565; A41D 13/1161

(57) ABSTRACT

A nonwoven suitable as a filtration media in provided. The nonwoven includes at least one layer including a plurality of submicron fibers directly or indirectly supported by a spunbond layer. Methods of making such nonwovens are also provided. Facemasks including such nonwovens are also provided.

### CROSS-REFERENCE TO RELATED APPLICATIONS

This application claims priority under 35 U.S.C. § 119(e) to U.S. Provisional Application No. 62/992,199, filed Mar. 20, 2020, which is expressly incorporated by reference herein in its entirety.

### TECHNICAL FIELD

Embodiments of the presently-disclosed invention relate generally to nonwovens suitable as a filtration media, in which the nonwovens include at least one layer including a plurality of submicron fibers (e.g., meltblown and/or melt fibrillated fibers) directly or indirectly supported by at least spunbond layer.

### BACKGROUND

Facemasks and respirators for filtering air inhaled by an individual have been in use for many years. There has recently been an increased awareness and concern for preventing contamination and infection of the public and health care personnel by airborne pathogens. Therefore, it has become highly desirable to prevent the spread of infections from person to person, from patient to health care worker and vice versa by preventing or mitigating inhalation or exhalation of airborne infectious aerosols and/or particulate matter. With recent outbreaks, for example, of the SARS virus and the COVID-19 virus, the spread of such airborne pathogens and has become an even greater concern on the minds of public health officials due to their potential undesirable impact(s).

There remains a need, therefore, for filtration media that may be easily distributed and worn by a multitude of the general public that prevents or mitigates the risks associated with the inhalation, exhalation, and/or transmission of airborne pathogens.

### SUMMARY OF INVENTION

One or more embodiments of the invention may address one or more of the aforementioned problems. Certain embodiments according to the invention provide a nonwoven comprising one of the following structures:

(Structure 1) S1ₐ-M_{b}-S2_{c};

(Structure 2) S1ₐ-N_{d}-S2_{c};

(Structure 3) S1ₐ-M_{b}-N_{d}-S2_{c};

(Structure 4) S1ₐ-N_{d}-S3ₑ-N_{d}-S2_{c};

(Structure 5) S1ₐ-N_{d}-M_{b}-N_{d}-S2_{c}

(Structure 6) S1ₐ-M_{b}-S3ₑ-M_{b}-S2_{c};

(Structure 7) S1ₐ-M_{b}-N_{d}-M_{b}-S2_{c}; or any combinations thereof;

wherein

‘M’ comprises a meltblown layer;

‘N’ comprises a melt-fibrillated fiber-containing layer;

‘S1’ comprises a first spunbond layer;

‘S2’ comprises a second spunbond layer;

‘S3’ comprises a third spunbond layer;

‘a’ represents the number of layers and is independently selected from 1, 2, 3, 4, and 5;

‘b’ represents the number of layers is independently selected from 1, 2, 3, 4, and 5;

‘c’ represents the number of layers is independently selected from 1, 2, 3, 4, and 5; and

‘d’ represents the number of layers is independently selected from 1, 2, 3, 4, and 5;

‘e’ represents the number of layers is independently selected from 1, 2, 3, 4, and 5;

wherein the nonwoven includes at least one layer comprising submicron fibers supported directly or indirectly by at least one spunbond layer.

In another aspect, the present invention provides a method of making a nonwoven suitable as a filter media, such as those described and disclosed herein. In accordance with certain embodiments of the invention, the method may comprise providing a first spunbond layer, depositing at least one melt-fibrillated layer and/or at least one meltblown layer directly or indirectly onto the first spunbond layer, and depositing a second spunbond layer directly or indirectly onto the at least one melt-fibrillated layer and/or at least one meltblown layer.

In yet another aspect, the present invention provides a facemask comprising a central body portion comprising a nonwoven, such as those described and disclosed herein, and a periphery region surrounding the central body portion. The facemask may also include at least one strap attached to the periphery region.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a facemask in accordance with certain embodiments of the invention being worn by a user.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to nonwovens suitable as a filtration media, in which the nonwovens include at least one layer including a plurality of submicron fibers (e.g., meltblown and/or melt fibrillated fibers) directly or indirectly supported by at least spunbond layer. In accordance with certain embodiments of the invention, the nonwoven may include one or more layers of melt-film fibrillated fibers that may be directly or indirectly supported on one or more spunbond layers, which may function as a supporting layer for the one or more layers of melt-film fibrillated fibers.

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process.

The term “layer”, as used herein, may comprise a generally recognizable combination of similar material types and/or functions existing in the X-Y plane.

The term “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to mechanically entangle, thermally bond, or otherwise bond, at least a portion of the individually fibers together to form a coherent (e.g., united) web of interconnected fibers.

The term “consolidated” and “consolidation”, as used herein, may comprise the bringing together of at least a portion of the fibers of a nonwoven web or of a plurality of nonwoven webs into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Such a web may be considered a “consolidated nonwoven”, “nonwoven fabric” or simply as a “fabric” according to certain embodiments of the invention.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous as disclosed and described herein. It is noted that the spunbond used in certain composites of the invention may include a nonwoven described in the literature as SPINLACE®.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers may comprise microfibers which may be continuous or discontinuous and are generally tacky when deposited onto a collecting surface. Meltblown fibers, however, are shorter in length than those of spunbond fibers.

The term “melt fibrillation”, as used herein, may comprise a general class of making fibers defined in that one or more polymers are molten and may be extruded into many possible configurations (e.g. co-extrusion, homogeneous or bicomponent films or filaments) and then fibrillated or fiberized into a plurality of individual filaments for the formation of melt-fibrillated fibers. Non limiting examples of melt-fibrillation methods may include melt blowing, melt fiber bursting, and melt film fibrillation. The term “melt-film fibrillation”, as used herein, may comprise a method in which a melt film is produced from a melt and then a fluid is used to form fibers (e.g., melt-film fibrillated fibers) from the melt film. Examples include U.S. Pat. Nos. 6,315,806, 5,183,670, 4,536,361, 6,382,526, 6,520,425, and 6,695,992, in which the contents of each are incorporated by reference herein to the extent that such disclosures are consistent with the present disclosure. Additional examples include U.S. Pat. Nos. 7,628,941, 7,722,347, 7,666,343, 7,931,457, 8,512,626, and 8,962,501, which describe the Arium' melt-film fibrillation process for producing melt-film fibrillated fibers (e.g., having sub-micron fibers).

As used herein, the term “aspect ratio”, comprise a ratio of the length of the major axis to the length of the minor axis of the cross-section of the fiber in question.

The term “multi-component fibers”, as used herein, may comprise fibers formed from at least two different polymeric materials or compositions (e.g., two or more) extruded from separate extruders but spun together to form one fiber. The term “bi-component fibers”, as used herein, may comprise fibers formed from two different polymeric materials or compositions extruded from separate extruders but spun together to form one fiber. The polymeric materials or polymers are arranged in a substantially constant position in distinct zones across the cross-section of the multi-component fibers and extend continuously along the length of the multi-component fibers. The configuration of such a multi-component fiber may be, for example, a sheath/core arrangement wherein one polymer is surrounded by another, an eccentric sheath/core arrangement, a side-by-side arrangement, a pie arrangement, or an “islands-in-the-sea” arrangement, each as is known in the art of multicomponent, including bicomponent, fibers.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

Certain embodiments according to the invention provide nonwovens suitable as a filtration media (e.g., bacterial filtration efficiency of at least 95%), in which the nonwoven includes at least one layer including a plurality of submicron fibers (e.g., meltblown and/or melt fibrillated fibers) directly or indirectly supported by at least spunbond layer. For example, the nonwoven suitable as a filtration media may comprise a nonwoven comprising one of the following structures:

(Structure 1) S1ₐ-M_{b}-S2_{c};

(Structure 2) S1ₐ-N_{d}-S2_{c};

(Structure 3) S1 ₐ-M_{b}-N_{d}-S2_{c};

(Structure 4) S1ₐ-N_{d}-S3ₑ-N_{d}-S2_{c};

(Structure 5) S1ₐ-N_{d}-M_{b}-N_{d}-S2_{c}

(Structure 6) S1ₐ-M_{b}-S3ₑ-M_{b}-S2_{c};

(Structure 7) S1ₐ-M_{b}-N_{d}-M_{b}-S2_{c}; or any combinations thereof;

wherein

‘M’ comprises a meltblown layer;

‘N’ comprises a melt-fibrillated fiber-containing layer;

‘S1’ comprises a first spunbond layer;

‘S2’ comprises a second spunbond layer;

‘S3’ comprises a third spunbond layer;

‘a’ represents the number of layers and is independently selected from 1, 2, 3, 4, and 5;

‘b’ represents the number of layers is independently selected from 1, 2, 3, 4, and 5;

‘c’ represents the number of layers is independently selected from 1, 2, 3, 4, and 5; and

‘d’ represents the number of layers is independently selected from 1, 2, 3, 4, and 5;

‘e’ represents the number of layers is independently selected from 1, 2, 3, 4, and 5;

wherein the nonwoven includes at least one layer comprising submicron fibers supported by a spunbond layer.

By way of example only, the nonwoven may comprise a structure according to Structure 1, in which ‘a’ is 2, ‘b’ is 2, and ‘c’ is 1 to provide a SSMMS structure. Similarly, the nonwoven may comprise a structure according to Structure 2, in which a′ is 2, ‘b’ is 2, and ‘c’ is 1 to provide a SSNNS structure. In accordance with certain embodiments of the invention, the nonwoven may have a structure according to, for example, Structure 4 in which ‘a’ is 2, ‘d’ is 2, and ‘c’ is 1, and e′ is 2 to provide a SSNNSSNNS structure. In accordance with certain embodiments of the invention, the nonwoven may have a structure according to, for example, Structure 7 in which ‘a’ is 2, ‘b’ is 1, ‘d’ is 2, and ‘c’ is 1 to provide a SSMNNMS structure.

As noted above, each of the number of layers denoted by subscripts ‘a’, ‘b’, ‘c’, ‘d’, and ‘e’ may be selected independent of each other. For example, a nonwoven may have a SSNNSNNNSSS structure in accordance with Structure 4. For instance, the value for subscript ‘d’ for the N layer(s) between S1 and S3 need not be identical to the value for the subscript ‘d’ for the N layer(s) between S3 and S2. In this regard, the values of ‘d’ may be selected independent from each other, for example, for nonwovens according to Structures 4 and 5. In accordance with certain embodiments, the values of ‘b’ may be selected independent from each other, for example, for nonwovens according to Structures 6 and 7.

In accordance with certain embodiments of the invention, the nonwoven may comprise any combination of Structures 1-7. For example, a precursor nonwoven according to Structure 1 may be combined with a precursor nonwoven according to a second precursor nonwoven according to Structure 3 (e.g., directly or indirectly bonded or contained in a common housing although not physically bonded together). In this regard, the nonwoven may comprise a variety of combinations of layers by joining and/or bonding nonwovens (e.g., precursor nonwovens) according to Structures 1-7 in a multitude of different configurations.

In accordance with certain embodiments of the invention, the nonwoven includes at least one melt-fibrillated layer (N) including melt-fibrillated fibers having an average diameter from about 0.3 microns to about 0.8 microns, such as at least about any of the following: 0.3, 0.4, 0.5, and 0.6 microns, and/or at most about any of the following: 0.8, 0.7, 0.6, and 0.5 microns. In accordance with certain embodiments of the invention, the melt-fibrillated layer (N) comprises melt-film fibrillated fibers.

The melt-fibrillated fibers, in accordance with certain embodiments of the invention, may comprise a synthetic polymer or polymeric material, such as a polyolefin, a polyester, a polyamide, or any combination thereof. For instance, the synthetic polymer or polymeric material may comprise of consist of a polyolefin comprising a polypropylene, a polypropylene copolymer, a polyethylene, a polyethylene copolymer, or any combination thereof

In accordance with certain embodiments of the invention, the nonwoven includes at least one meltblown layer (M) including a plurality of meltblown fibers having an average diameter from about 0.5 microns to about 5 microns, such as at least about any of the following: 0.5, 0.8, 1, 1.5, 2, 2.5, and 3 microns, and/or at most about any of the following: 5, 4.5, 4, 3.5, 3, and 2.5 microns.

The meltblown fibers, in accordance with certain embodiments of the invention, may comprise a synthetic polymer or polymeric material, such as a polyolefin, a polyester, a polyamide, or any combination thereof. For instance, the synthetic polymer or polymeric material may comprise of consist of a polyolefin comprising a polypropylene, a polypropylene copolymer, a polyethylene, a polyethylene copolymer, or any combination thereof

In accordance with certain embodiments of the invention, the nonwoven includes a first outer spunbond layer including a first plurality of continuous spunbond fibers and a second outer spunbond layer including a second plurality of continuous spunbond fibers, wherein the first plurality of spunbond fibers, the second plurality of spunbond fibers, or both have an average decitex (dtex) value from about 1 to about 3 dtex, such as at least about any of the following: 1, 1.2, 1.5, 1.8, and 2 dtex and/or at most about any of the following: 3, 2.8, 2.5, 2.2, and 2 dtex. In accordance with certain embodiments of the invention, the first plurality of spunbond fibers, the second plurality of spunbond fibers, or both independently comprise a synthetic polymer, such as a polyolefin, a polyester, a polyamide, or any combination thereof. For example, the polyolefin may comprise or consist of a polypropylene, a polypropylene copolymer, a polyethylene, a polyethylene copolymer, or any combination thereof

In accordance with certain embodiments of the invention, the nonwoven may comprise a basis weight from about 20 to about 150 grams-per-square (gsm), such as from at least about any of the following: 20, 30, 40, 50, 60, 70, 80, 90, and 100 gsm and/or at most about any of the following: 150, 140, 130, 120, 110, and 100 gsm.

In accordance with certain embodiments of the invention, the nonwoven includes at least one melt-fibrillated layer (N) comprising a basis weight from about 0.5 to about 10 gsm, such as at least about any of the following: 0.5, 1, 2, 3, 4, and 5 gsm, and/or at most about any of the following: 10, 9, 8, 7, 6, and 5 gsm. In accordance with certain embodiments of the invention, the nonwoven includes a plurality of melt-fibrillated layers, wherein each individual melt-fibrillated layer independently has a basis weight from about 0.5 to about 10 gsm, such as at least about any of the following: 0.5, 1, 2, 3, 4, and 5 gsm, and/or at most about any of the following: 10, 9, 8, 7, 6, and 5 gsm. In accordance with certain embodiments of the invention, the nonwoven includes a plurality of melt-fibrillated layers having an aggregated melt-fibrillated basis weight from about 1 to about 30 gsm, such as at least about any of the following: 1, 2, 3, 4, 5, 8, 10, 12, 15, 18, and 20 gsm, and/or at most about any of the following: 30, 28, 25, 22, and 20 gsm.

In accordance with certain embodiments of the invention, the nonwoven includes a plurality of meltblown layers, wherein each individual meltblown layer independently has a basis weight from about 0.5 to about 10 gsm, such as at least about any of the following: 0.5, 1, 2, 3, 4, and 5 gsm, and/or at most about any of the following: 10, 9, 8, 7, 6, and 5 gsm. In accordance with certain embodiments of the invention, the nonwoven includes a plurality of meltblown layers having an aggregated meltblown basis weight from about 1 to about 30 gsm, such as at least about any of the following: 1, 2, 3, 4, 5, 8, 10, 12, 15, 18, and 20 gsm, and/or at most about any of the following: 30, 28, 25, 22, and 20 gsm.

In accordance with certain embodiments of the invention, the nonwoven includes a plurality of spunbond layers, wherein each individual spunbond layer independently has a basis weight from about 3 to about 30 gsm, such as at least about any of the following: 3, 5, 8, 10, 12, 15, 18, and 20 gsm, and/or at most about any of the following: 30, 28, 25, 22, 20, 18, and 15 gsm. In accordance with certain embodiments of the invention, the nonwoven includes a plurality of spunbond layers having an aggregated spunbond basis weight from about 6 to about 90 gsm, such as at least about any of the following: 6, 8,10, 15, 20, 25, 30, 35, 40, 45, 50, 55, and 60 gsm, and/or at most about any of the following: 90, 85, 80, 75, 70, 65, 60, 55, and 50 gsm.

In accordance with certain embodiments of the invention, the nonwoven comprises a variable porosity through the thickness of the nonwoven fabric. For example, the nonwoven may include a first outer surface having a first porosity, a second outer surface, and an interior region including a mid-point between the first outer surface and the second outer surface in the z-direction and having second porosity; wherein the first porosity is larger than the second porosity. In this regard, larger particulates and/or larger aerosolized components may be captured or blocked at or near the outermost surface, while the relatively smaller particulates and/or smaller aerosolized components may be captured or blocked within an interior region of the nonwoven. In accordance with certain embodiments of the invention, for instance, the nonwoven comprises a depth-filtration media without undesirably high pressure drops across the nonwoven. For example, the pressure drop or differential pressure across the nonwoven may comprise less than about 60 Pa/cm².

In accordance with certain embodiments of the invention, the nonwoven has a Bacterial Filtration Efficiency (BFE) for particles having a size of, for example, 3 microns of at least 95%, such as at least 96%, at least 97%, at least 98%, or at least 99%. The BFE of a filter material is generally arrived at by determining the percentage of bacteria, such as Staphylococcus aureus or Bacillus stearothermophilus, that is able to migrate through the filter material under normal condition. The fewer bacteria which are able to pass through the filter material, the higher the BFE.

In accordance with certain embodiments of the invention, one or more of the individual layers may comprise electrically charged fibers. For instance, electrically charged fibers may include fibers that possess an electric charge that is capable of being measured and is present on the fibers for more than transitory duration. The electrical charge may be imparted to the nonwoven after formation or to one or more the individual layers during or prior to final formation of the nonwoven to improve its filtering efficiency. For example, the meltblown and/or melt-fibrillated fibers may comprise an electrical charge while the spunbond layers (e.g., outer spunbond layers) may be not have received an electrical charge thereon. Alternatively, each layer of the nonwoven may comprise an electrical charge thereon.

In accordance with certain embodiments of the invention, one or more of the individual layers may optionally include a plurality of substrate nanoparticles embedded within or on the surface of the plurality of fibers forming the individual layer(s) including such nanoparticles. For example, the substrate nanoparticles may include anti-microbial substrates. The term “anti-microbial substrates” may include, in accordance with certain embodiments of the invention, any chemicals or particles that may be used to kill or make unviable microbes, viruses or bacteria. Examples of anti-microbial substrates may include nano-particles made of magnesium oxide (MgO), silver (Ag) compounds including silver nitrate, titanium oxide nanoparticles, Poly(N-benzyl-4-vinylpyridinium chloride), or combinations thereof

In accordance with certain embodiments of the invention, magnesium oxides may be effective biocides against gram positive and gram-negative bacteria such as E. coli and Bacillus megaterium, and against bacterial spores such as Bacillus Subtillus. Silver nanoparticles may be effective biocides for gram positive and gram-negative bacteria such as Staphylococcus aureus, E. coli, Klebsiella pneumoniae and Pseudomonas aeruginosa.

Titanium oxide nanoparticles, in accordance with certain embodiments of the invention, may also be used to kill bacteria and viruses after the nanoparticles are activated by ultraviolet light to produce strong oxidation reaction. Titanium oxide nanoparticles may be embedded within or adhered to the surface of the fibers in the one or more of the individual layers of the nonwoven. When activated by ultraviolet light in the visual light spectrum, titanium oxide nanoparticles may kill entrapped virus and bacteria that may get caught by the nonwoven. An example of an organic compound that may be an anti-microbial substrate includes Poly(N-benzyl-4-vinylpyridinium chloride), which has a strong affinity to virus bacteriophage T4 and a mean pore size of about 14.7 microns.

The substrate nanoparticles may also include adsorption particles. The term “adsorption particles” may include nano-sized adsorbents, with molecule sizes from about 0.5 to about 100 nanometers, that may physically attract and adsorb particles and volatile organic compounds (VOCs) from an air stream to the surface of the adsorption particle. This attraction may involve electrostatic or chemical interaction. For instance, the adsorption particles may be used to remove particles and VOCs from the air stream, in addition to the tortious network of fibers associated with the nonwoven.

Examples of adsorption particles may include activated carbon, silica gel, activated alumina, zeolites, porous clay minerals, molecular sieves, or combinations thereof. Nano-sized absorbents made of zinc oxide, calcium oxide, cupric oxide, magnesium oxide, manganese dioxide, manganese oxide, aluminum oxide, and zeolite may also be used to filter specific molecules such as hydrogen sulphide. In one example, activated carbon nanoparticles with surface areas from about 10 to about 104 meter square per gram (m²/g) and particle porosities of 40-90% may be used to filter or trap odor and/or smoke particles.

One or more nonwovens, in accordance with certain embodiments of the invention, may be subjected to a consolidating process as previously noted. For example, one or more nonwovens may be thermally bonded (independently or together) and comprise a bonded area from about 8% to about 30%, such as at least about any of the following: 8, 19, 12, 15, 18, and 20%, and/or at most about any of the following: 30, 28, 25, 22, 20, and 18%. In accordance with certain embodiments, a nonwoven according to anyone of Structures 1-7 may be consolidated and bonded to a second nonwoven according to anyone of Structures 1-7. In this regard, a resulting nonwoven fabric may include one or more nonwovens, such as those having structures outlined by Structures 1-7, consolidated together to provide a single sheet material suitable as a filter media.

In another aspect, the present invention provides a method of making a nonwoven suitable as a filter media, such as those described and disclosed herein. In accordance with certain embodiments of the invention, the method may comprise providing a first spunbond layer, depositing at least one melt-fibrillated layer and/or at least one meltblown layer directly or indirectly onto the first spunbond layer, and depositing a second spunbond layer directly or indirectly onto the at least one melt-fibrillated layer and/or at least one meltblown layer.

In accordance with certain embodiments of the invention, the nonwoven may be formed by bonding together two or more precursor nonwovens to provide the final nonwoven suitable as a BFE filter media. For example, a first so-called precursor nonwoven may comprise a S-(M or N)-S structure (e.g., where each S, M, and/or N layer may include one or a plurality of such layers) and a second precursor nonwoven may also comprise a general S-(M or N)-S structure (e.g., where each S, M, and/or N layer may include one or a plurality of such layers) to provide, for example only, a nonwoven BFE filtration media having a SSNSNSS structure or a SSNNSSSSNNSS structure.

In accordance with certain embodiments of the invention, the method may further comprising thermally bonding the individual layers together or precursor nonwoven together to provide the final nonwoven suitable as a BFE filter media. The thermal bonding operation, for example, may comprise thermal calendering, ultrasonic bonding, or both. For example, one or more nonwovens, in accordance with certain embodiments of the invention, may be subjected to a consolidating process as previously noted. For example, one or more nonwovens may be thermally bonded (independently or together) and comprise a bonded area from about 8% to about 30%, such as at least about any of the following: 8, 19, 12, 15, 18, and 20%, and/or at most about any of the following: 30, 28, 25, 22, 20, and 18%. In accordance with certain embodiments, a nonwoven according to anyone of Structures 1-7 may be consolidated and bonded to a second nonwoven according to anyone of Structures 1-7. In this regard, a resulting nonwoven fabric may include one or more nonwovens, such as those having structures outlined by Structures 1-7, consolidated together to provide a single sheet material suitable as a filter media.

In yet another aspect, the present invention provides a facemask comprising a central body portion comprising a nonwoven, such as those described and disclosed herein, and a periphery region surrounding the central body portion. The facemask may also include at least one strap attached to the periphery region. In accordance with certain embodiments of the invention, the facemask may include a bendable reinforcement nose bar, which may be formed from a metal material. In accordance with certain embodiments of the invention, the at least one strap (e.g., two separate straps) comprises an elastic material. The periphery portion, for example, may comprise a moldable material that is different than the central body portion. For example, the moldable material may form an air-tight seal to an individual wearing the facemask.

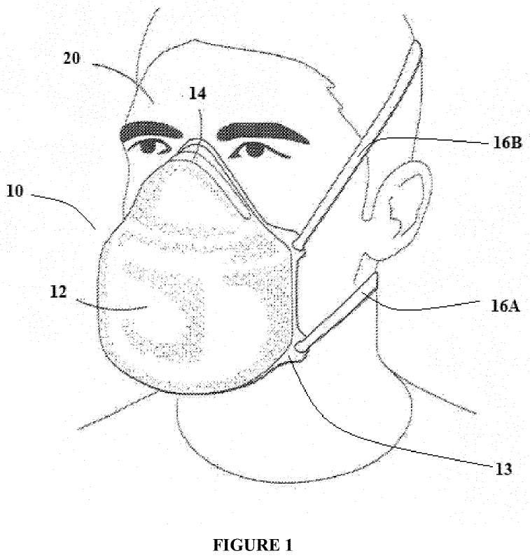

FIG. 1, for instance, a facemask 10 in accordance with certain embodiments of the invention being worn by a user 20. The facemask 10 includes a central body portion 12 formed from a nonwoven as described and disclosed herein and a periphery region 13, which may be formed from the same of different material as the central body portion. As shown in FIG. 1, the facemask 10 also includes a bendable reinforcement nose bar 14 as well as two straps 16A,16B.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A nonwoven comprising one of the following structures:
(Structure 1) S1ₐ-M_{b}-S2_{c};
(Structure 2) S1ₐ-N_{d}-S2_{c};
(Structure 3) S1ₐ-M_{b}-N_{d}-S2_{c};
(Structure 4) S1ₐ-N_{d}-S3ₑ-N_{d}-S2_{c};
(Structure 5) S1ₐ-N_{d}-M_{b}-N_{d}-S2_{c}
(Structure 6) S1ₐ-M_{b}-S3ₑ-M_{b}-S2_{c};
(Structure 7) S1ₐ-M_{b}-N_{d}-M_{b}-S2_{c}; or any combinations thereof;
wherein
‘M’ comprises a meltblown layer;
‘N’ comprises a melt-fibrillated fiber-containing layer;
‘S1’ comprises a first spunbond layer;
‘S2’ comprises a second spunbond layer;
‘S3’ comprises a third spunbond layer;
‘a’ represents the number of layers and is independently selected from 1, 2, 3, 4, and 5;
‘b’ represents the number of layers is independently selected from 1, 2, 3, 4, and 5;
‘c’ represents the number of layers is independently selected from 1, 2, 3, 4, and 5; and
‘d’ represents the number of layers is independently selected from 1, 2, 3, 4, and 5;
‘e’ represents the number of layers is independently selected from 1, 2, 3, 4, and 5;
wherein the nonwoven includes at least one layer comprising submicron fibers supported by a spunbond layer.

2. The nonwoven of claim 1, wherein the nonwoven includes at least one melt-fibrillated layer (N) including melt-fibrillated fibers having an average diameter from about 0.3 microns to about 0.8 microns.

3. The nonwoven of claim 2, wherein the melt-fibrillated layer (N) comprises melt-film fibrillated fibers.

4. The nonwoven of claim 1, wherein the nonwoven includes at least one meltblown layer (M) including a plurality of meltblown fibers having an average diameter from about 0.5 microns to about 5 microns.

5. The nonwoven of claim 1, wherein the nonwoven includes a first outer spunbond layer including a first plurality of continuous spunbond fibers and a second outer spunbond layer including a second plurality of continuous spunbond fibers, wherein the first plurality of spunbond fibers, the second plurality of spunbond fibers, or both have an average decitex (dtex) value from about 1 to about 3 dtex.

6. The nonwoven of claim 5, wherein the first plurality of spunbond fibers, the second plurality of spunbond fibers, or both independently comprise a synthetic polymer.

7. The nonwoven of claim 1, wherein the nonwoven comprises a basis weight from about 20 to about 150 grams-per-square (gsm).

8. The nonwoven of claim 7, wherein the nonwoven includes at least one melt-fibrillated layer (N) comprising a basis weight from about 0.5 to about 10 gsm.

9. The nonwoven of claim 8, wherein the nonwoven includes a plurality of melt-fibrillated layers, wherein each individual melt-fibrillated layer independently has a basis weight from about 0.5 to about 10 gsm.

10. The nonwoven of claim 9, wherein the nonwoven includes a plurality of melt-fibrillated layers having an aggregated melt-fibrillated basis weight from about 1 to about 30 gsm.

11. The nonwoven of claim 8, wherein the nonwoven includes a plurality of individual meltblown layers, wherein each individual meltblown layer independently has a basis weight from about 0.5 to about 10 gsm.

12. The nonwoven of claim 8, wherein the nonwoven includes a plurality of meltblown layers having an aggregated meltblown basis weight from about 1 to about 30 gsm.

13. The nonwoven of claim 1, wherein the nonwoven comprises a variable porosity through the thickness of the nonwoven fabric.

14. The nonwoven of claim 13, wherein the nonwoven includes a first outer surface having a first porosity, a second outer surface, and an interior region including a mid-point between the first outer surface and the second outer surface in the z-direction and having a second porosity; wherein the first porosity is larger than the second porosity.

15. The nonwoven of claim 1, wherein the nonwoven has a Bacterial Filtration Efficiency (BFE) of at least 95%.

16. A method of making a nonwoven, comprising:
providing a first spunbond layer;
depositing at least one melt-fibrillated layer and/or at least one meltblown layer directly or indirectly onto the first spunbond layer; and
depositing a second spunbond layer directly or indirectly onto the at least one melt-fibrillated layer and/or at least one meltblown layer.

17. The method claim 16, wherein the nonwoven includes at least one melt-fibrillated layer formed via a melt-film fibrillation process.

18. The method of claim 16, further comprising thermally bonding the first spunbond layer, the at least one melt-fibrillated layer and/or at least one meltblown layer, and the second spunbond layer together.

19. A facemask, comprising:
(i) a central body portion comprising a nonwoven, the nonwoven comprising one of the following structures:
(Structure 1) S1ₐ-M_{b}-S2_{c};
(Structure 2) S1ₐ-N_{d}-S2_{c};
(Structure 3) S1ₐ-M_{b}-N_{d}-S2_{c};
(Structure 4) S1ₐ-N_{d}-S3ₑ-N_{d}-S2_{c};
(Structure 5) S1ₐ-N_{d}-M_{b}-N_{d}-S2_{c}
(Structure 6) S1ₐ-M_{b}-S3ₑ-M_{b}-S2_{c};
(Structure 7) S1ₐ-M_{b}-N_{d}-M_{b}-S2_{c}; or any combinations thereof;
wherein
‘M’ comprises a meltblown layer;
‘N’ comprises a melt-fibrillated fiber-containing layer;
‘S1’ comprises a first spunbond layer;
‘S2’ comprises a second spunbond layer;
‘S3’ comprises a third spunbond layer;
‘a’ represents the number of layers and is independently selected from 1, 2, 3, 4, and 5;
‘b’ represents the number of layers is independently selected from 1, 2, 3, 4, and 5;
‘c’ represents the number of layers is independently selected from 1, 2, 3, 4, and 5; and
‘d’ represents the number of layers is independently selected from 1, 2, 3, 4, and 5;
‘e’ represents the number of layers is independently selected from 1, 2, 3, 4, and 5;
wherein the nonwoven includes at least one layer comprising submicron fibers supported by a spunbond layer;
(ii) a periphery region surrounding the central body portion; and
(iii) at least one strap attached to the periphery region.

20. The facemask of claim 19, further comprising a bendable reinforcement nose bar, wherein the bendable reinforcement nose bar comprises a metal material.
